(19) United States
(12) Patent Application Publication
(10) Pub. No.: US 2012/0150495 A1
(43) Pub. Date: Jun. 14, 2012

(54) THREE-DIMENSIONAL CATALYTIC CONVERTER MODELING

(75) Inventors: Atul Pant, Bangalore (IN); Thiyagarajan Paramadhayalan, Bangalore (IN)

(73) Assignee: GM GLOBAL TECHNOLOGY OPERATIONS LLC, Detroit, MI (US)

(21) Appl. No.: 12/962,876

(22) Filed: Dec. 8, 2010

(51) Int. Cl. G06F 17/11

(52) U.S. Cl. 703/2

(57) ABSTRACT

A computing device includes a first module configured to determine at least one quantity at a plurality of axial locations in a catalytic converter. Each axial location extends in a direction that is generally parallel to a direction of flow of exhaust gas through the catalytic converter. The computing device further includes a second module configured to receive the quantity determined by the first module and solve the three-dimensional model of the catalytic converter based at least in part on the received quantity.

### TECHNICAL FIELD

The invention relates to three-dimensional modeling of a catalytic converter.

### BACKGROUND

Passenger and commercial vehicles may use an engine that creates exhaust gases. Instead of releasing these exhaust gases into the atmosphere, the vehicle may include a catalytic converter that may improve the quality of the exhaust gases to, for instance, reduce pollution. Therefore, the catalytic converter helps the vehicle meet emissions standards.

### SUMMARY

A computing device includes a first module configured to determine at least one quantity of a chemical reaction at a plurality of axial locations in a catalytic converter. Each axial location extends in a direction that is generally parallel to a direction of flow of exhaust gas through the catalytic converter. A second module is configured to receive the quantity determined by the first module and solve the three-dimensional model of the catalytic converter based at least in part on the received quantity.

A method includes determining, via a first module of a computing device, a first quantity of a chemical reaction at a first axial location of a catalytic converter and determining, via the first module, a second quantity of the chemical reaction at a second axial location of the catalytic converter. The method further includes receiving the first and second quantity at a second module of the computing device and generating, via the second module, a three-dimensional model of the catalytic converter based at least in part on the first quantity and the second quantity.

Another computing device includes a first module configured to determine a first quantity of heat released and a first amount of species consumed or generated at a first axial location of a catalytic converter during a chemical reaction. The first module is further configured to determine a second quantity of heat released and a second amount of species consumed or generated at a second axial location of the catalytic converter during the chemical reaction. The first and second axial locations each extend in a direction that is generally parallel to a direction of flow of exhaust gas through the catalytic converter. A second module is configured to receive the first quantity of heat released, the second quantity of heat released, the first amount of species consumed or generated, and the second amount of species consumed or generated during the chemical reaction. The second module is configured to solve the three-dimensional model of the catalytic converter based at least in part on one or more of the first quantity of heat released, the second quantity of heat released, the first amount of species consumed or generated, and the second amount of species consumed or generated during the chemical reaction.

In the example approaches disclosed herein, the first module is able to model chemical reactions at each axial location, which may reduce the time the second module spends generating the three-dimensional model of the catalytic converter.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a vehicle having an engine and a catalytic converter.

FIG. 2 is a schematic diagram of a computing device used to model the catalytic converter.

FIG. 3 illustrates a flowchart of an example process that may be implemented by the computing device.

FIG. 4 illustrates a flowchart of an example process that may be implemented by a module of the computing device.

FIG. 5 illustrates a flowchart of an example process that may be implemented by a module of the computing device.

### DETAILED DESCRIPTION

A computing device that may be used to solve a three-dimensional model of a catalytic converter includes a first module configured to determine at least one quantity at a plurality of axial locations in the catalytic converter. Each axial location extends in a direction that is generally parallel to a direction of flow of exhaust gas through the catalytic converter. The quantities determined by the first module may be associated with a chemical reaction inside the catalytic converter. For example, the quantities may include a quantity of heat released, an amount of species consumed and/or generated (e.g., an amount of mass balanced), or both, at a plurality of axial locations. The computing device further includes a second module configured to receive the quantity determined by the first module and solve the three-dimensional model of the catalytic converter based at least in part on the received quantity. Because the first module is able to determine the quantities associated with chemical reactions at each axial location, the second module is able to more quickly solve the three-dimensional model of the catalytic converter.

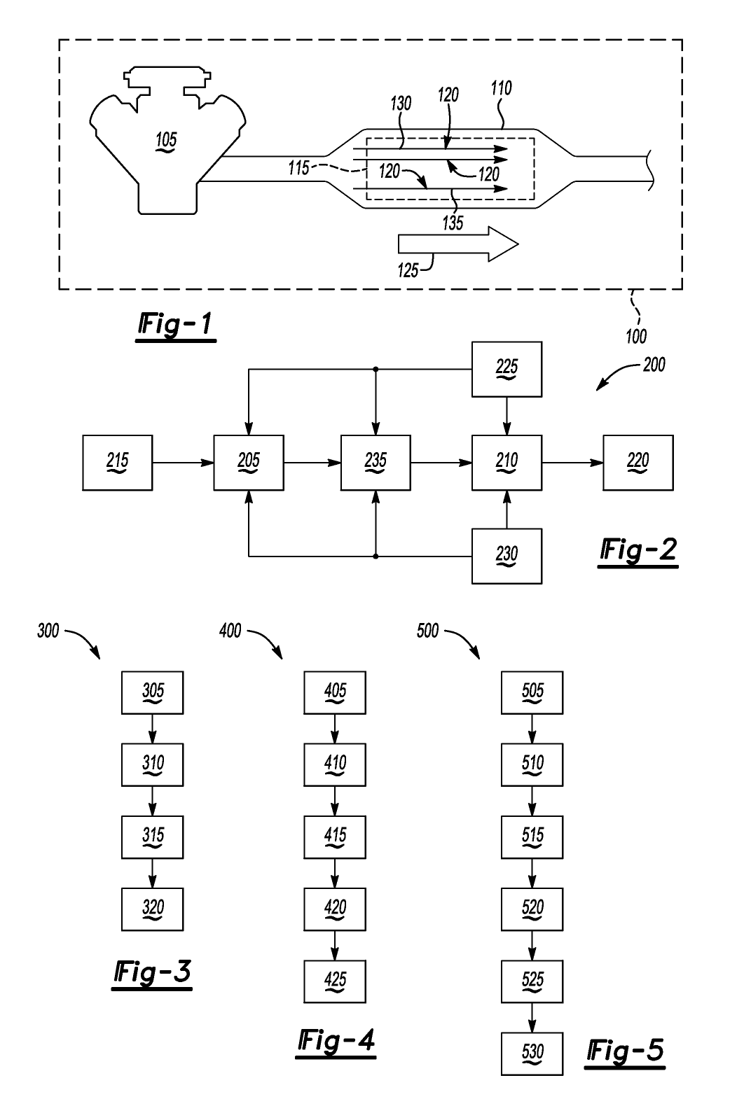

FIG. 1 illustrates an example vehicle 100 with a catalytic converter that may be modeled by an example computing device 200 (see FIG. 2). The vehicle 100 may take many different forms and include multiple and/or alternate components and facilities. While an example vehicle 100 is shown in the Figures, the components illustrated in the Figures are not intended to be limiting. Indeed, additional or alternative components and/or implementations may be used.

The vehicle 100 may have an engine 105 and a catalytic converter 110. Thus, the vehicle 100 may be any passenger or commercial automobile such as a hybrid electric vehicle 100 including a plug-in hybrid electric vehicle 100 (PHEV) or an extended range electric vehicle 100 (EREV), a gas-powered vehicle 100, or the like.

The engine 105 may include any device configured to generate rotational motion by burning a fuel. For example, the engine 105 may include an internal combustion engine configured to burn a mixture of fuel and air to solve a torque. The engine 105 may be configured to operate in accordance with a two-stroke cycle, a four-stroke (e.g., Otto) cycle, a diesel cycle, or the like. In general, the fuel and air mixture may be combusted inside of a chamber leaving behind exhaust gases that may include carbon monoxide (CO), carbon dioxide (CO₂), oxygen (O₂), nitrogen (N₂), nitrogen oxides (NO and NO₂, also referred to as NOx), water vapor (H₂O), and/or hydrocarbons (HC). The exhaust gases may be released from the engine 105, e.g., at bottom dead center in a two-stroke cycle or during an exhaust stroke in a four-stroke cycle. The exhaust gases may be released from the engine 105 via an exhaust port. The flow of exhaust out of the engine 105 may be controlled by an exhaust valve.

The catalytic converter 110 may include any device operatively connected to the engine 105 and configured to improve the quality of the exhaust gases or emissions from the engine 105. The catalytic converter 110 may be configured to allow exhaust gases to flow through the catalytic converter 110 along a plurality of axial locations 120, including a first axial location 130 and a second axial location 135. Each axial location may extend in a direction that is generally parallel to the direction 125 of the flow of the exhaust gases. The catalytic converter 110 may have a catalyst 115 that facilitates a chemical reaction to reduce emissions when exposed to the exhaust gases without being consumed during the resulting chemical reaction. The chemical reactions facilitated by the catalyst 115 may cause, for example, the carbon monoxide in the exhaust gas to react with the oxygen in the exhaust gas to produce carbon dioxide (e.g., 2CO+O₂→2CO₂), the nitrogen oxides to break down into nitrogen and oxygen (e.g., 2NO→N₂+O₂ and 2NO₂→N₂+2O₂), etc.

The catalytic converter 110 may be configured to reduce emissions from the engine 105 in different stages. In one possible approach, the catalytic converter 110 may include a reduction catalyst 115 such as platinum or rhodium at a first stage to help reduce NOx emissions. Further, the catalytic converter 110 may include an oxidation catalyst 115 such as platinum or palladium to cause the carbon monoxide and hydrocarbon molecules in the exhaust gas to react with oxygen. The catalytic converter 110 may further include other stages to help reduce emissions. After undergoing the chemical reaction, the exhaust gases may be released from the catalytic converter 110 using an exhaust pipe.

FIG. 2 illustrates an example schematic diagram that may be used by a computing device 200 to solve a three-dimensional model of the chemical reactions using information about the chemical reactions determined at two or more axial locations 120 of the catalytic converter. In addition to the catalyst 115 involved, the physical configuration (e.g., size and shape) of the catalytic converter 110 may affect the way in which the catalytic converter 110 reduces emissions from the engine 105. As such, the computing device 200 may be used to model the chemical reactions at a plurality of axial locations 120 to, for instance, predict the actual reduction in emissions while designing the catalytic converter 110.

The computing device 200 may include a first module 205, a second module 210, and an initialization module 235. The computing device 200 may be configured to interact with a user via an input device 215 and an output device 220. The input device 215 may include any device configured to receive information from the user. Accordingly, the input device 215 may include a computer keyboard, a computer mouse, or both. The output device 220 may include any device configured to present information to the user. For example, the output device 220 may include a display device such as a computer monitor.

The first module 205 may include computer-executable code that is configured to receive and process information provided to the computing device 200 via the input device 215, the second module 210, or both. In one possible implementation, the first module 205 is configured to determine at least one quantity related to the chemical reactions of the exhaust gases in the catalytic converter at a plurality of axial locations 120. The at least one quantity may include a quantity of heat released, an amount of species consumed or generated (e.g., an amount of mass balanced), etc. for at least two axial locations 120 within the catalytic converter 110. Moreover, the first module 205 may be configured to output information to the second module 210.

In one possible implementation, the initialization module 235 may be configured to facilitate communication between the first module 205 and the second module 210. For example, the initialization module 235 may be configured to sort the axial locations 120 into an array that at least partially defines the catalytic converter 110. The initialization module 235 may be configured to separate the catalytic converter 110 into a plurality of cells. Each cell may be associated with one of the axial locations 120. The initialization module 235 may be further configured to arrange the cells into the array based on the axial location of the cell. That is, cells sharing the same axial location may be grouped together and any cell in the group may be accessed using axial coordinates and a local index number.

The first module 205 may be configured to solve for the quantity based on the chemical reaction that occurs in each cell. In one possible approach, the first module 205 may be configured to determine a first quantity of heat released and/or a first amount of species consumed or generated at the first axial location 130 and a second quantity of heat released and/or a second amount of species consumed or generated at the second axial location 135. The first module 205 may further output the determined quantity to the second module 210.

The second module 210 may include computer-executable code that is configured to solve a three-dimensional model of the catalytic converter 110 using, for instance, information from the first module 205 and/or information stored in a database 225 or other volatile or non-volatile memory device 230. For example, the physical dimensions of the catalytic converter 110, the chemical properties of the catalyst 115, the chemical properties of the exhaust gases, etc., may be stored in the database 225 and/or memory device 230.

The database 225 may include any data repositories or other data stores that is configured to store, access, and retrieve various kinds of data, including a hierarchical database, a set of files in a file system, an application database in a proprietary format, a relational database management system (RDBMS), etc. Each such data store may be generally included within a computing device employing a computer operating system, and may be accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language. The memory device 230 may include any computer-readable medium, described in detail below.

The second module 210 may be configured to solve the three-dimensional model by applying the information from the first module 205, the database 225, the memory device 230, or any combination of these sources of information to one or more equations and by solving the one or more equations for each axial location 120. For example, the second module 210 may be configured to receive the quantity of heat released and/or the amount of species consumed or generated at the first axial location 130 and the second axial location 135 during a chemical reaction as determined by the first module 205. The second module 210 may be further configured to apply the quantity of heat released, the amount of species consumed, generated, or both, at multiple axial locations 120 to equations specific to each axial location. Each equation may further consider the flow of exhaust gas through the catalytic converter 110. Using these equations, as well as other information stored in the database 225, the memory device 230, or both, the second module 210 may be configured to solve the three-dimensional model of the catalytic converter 110 and output the three-dimensional model to the display device.

In general, computing systems and/or devices, such as the computing device 200, may employ any of a number of computer operating systems and generally include computer-executable instructions, where the instructions may be executable by one or more computing devices such as those listed above. Computer-executable instructions may be compiled or interpreted from computer programs created using a variety of well known programming languages and/or technologies, including, without limitation, and either alone or in combination, Java™, C, C++, Visual Basic, Java Script, Perl, Fortran, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. As discussed above with respect to the memory device 230, non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

FIG. 3 illustrates an example process 300 that may be implemented by the computing device 200 to, for example, create a three-dimensional representation of the catalytic converter 110.

At block 305, the computing device 200 may determine a first quantity at a first axial location 130 of the catalytic converter 110 using the first module 205. In one possible approach, the computing device 200 may use the first module 205 to determine one or more quantities related to the chemical reactions of the exhaust gas inside the catalytic converter 110. For example, the first quantity may be the quantity of heat released or the amount of species consumed or generated during a chemical reaction at the first axial location 130. The first axial location 130 may extend in a direction that is generally parallel to a direction 125 of flow of exhaust gas through the catalytic converter 110.

At block 310, the computing device 200 may determine a second quantity at a second axial location 135 of the catalytic converter 110 using the first module 205. As discussed above, the computing device 200 may use the first module 205 to determine quantities related to chemical reactions of the exhaust gas at each axial location in the catalytic converter 110. The second quantity determined at block 310 may be the same type of quantity as determined at block 305, but at a different axial location. For instance, if the computing device 200 determines the quantity of heat released at the first axial location 130 at block 305, the computing device 200 may determine the quantity of heat released at the second axial location 135 at block 310. Similarly, if the computing device 200 determines the amount of species consumed or generated at the first axial location 130 at block 305, the computing device 200 may determine the amount of species consumed or generated at the second axial location 135 at block 310. The second axial location 135 may extend in a direction that is generally parallel to a direction 125 of flow of exhaust gas through the catalytic converter 110.

At block 315, the computing device 200 may receive the first quantity and the second quantity at the second module 210. For example, as discussed with respect to blocks 305 and 310, the first quantity and/or the second quantity may represent the quantity of heat released, the amount of species consumed, generated, or both, during the chemical reaction.

At block 320, the computing device 200 may solve the three-dimensional model of the catalytic converter 110 based at least in part on the first quantity and the second quantity. For instance, using the first quantity determined at the first location and the second quantity determined at the second location, the computing device 200, using the second module 210, may apply the first quantity to a first equation and the second quantity to a second equation. The results of the first and second equations may be used to solve the three-dimensional model. Moreover, the computing device 200 may output a graphical representation of the three-dimensional model to a user via the output device 220.

FIG. 4 illustrates an example process 400 that may be implemented by the second module 210 to, for instance, solve the three-dimensional model of the catalytic converter 110.

At block 405, the second module 210 may receive boundary conditions of the catalytic converter 110. The boundary conditions may represent the physical configuration (e.g., dimensions) of the catalytic converter 110 and may be stored in the memory device 230.

At block 410, the second module 210 may receive one or more of the quantities determined by the first module 205. As discussed above, the first module 205 is configured to determine one or more quantities related to chemical reactions of the exhaust gas at each axial location in the catalytic converter 110. The quantities received may include the quantity of heat released or the amount of species consumed or generated during the chemical reaction.

At block 415, the second module 210 may apply the quantities received to one or more equations. Each quantity received at block 410 may be associated with an axial location of the catalytic converter 110. The second module 210 may apply the quantity at each axial location to an equation. The equation may consider the flow of the exhaust gas through the catalytic converter 110, the quantity of heat released during the chemical reaction, and the amount of species consumed or generated during the chemical reaction.

At block 420, the second module 210 may solve the equations of block 415 using the quantities received at block 410. By doing so, the second module 210 may be able to define the chemical reaction at each axial location. For instance, the second module 210 may solve equations using the quantity of heat released, the amount of species consumed, generated, or both, at two or more axial locations 120.

At block 425, the second module 210 may solve (e.g., generate) the three-dimensional model and output the three-dimensional model to a user via the output device 220. For instance, the second module 210 may form an array defined by multiple axial locations 120, and create the three-dimensional model based on the defined array and the solutions determined at block 420. This way, the second module 210 may solve the three-dimensional model using the quantity of heat released, the amount of species consumed, generated, or both, at two or more axial locations 120.

FIG. 5 illustrates an example process 500 that may be used by the first module 205 and the initialization module 235 so that the first module 205 may determine one or more quantities at each of the axial locations 120. In one possible approach, blocks 505, 510, and 515 may be performed by the initialization module 235 during a first iteration of the process 500, while blocks 520, 525, and 530 may be performed by the first module 205 during all iterations of the process 500.

At block 505, the initialization module 235 may read and store the different axial locations 120 of the catalytic converter 110. These axial locations 120 may be determined from the physical properties of the catalytic converter 110 stored in the memory device 230. In one possible implementation, the second module 210 may determine the different axial locations 120 and transmit the axial locations 120 to the first module 205.

At block 510, the initialization module 235 may sort the catalytic converter 110 into a plurality of cells. Each cell may be associated with an axial location 120 of the catalytic converter 110. For instance, cells sharing the same axial location may be grouped together and any cell in the group may be accessed using axial coordinates and a local index number.

At block 515, the initialization module 235 may allocate an array size. The array size may be based on the physical configuration of the catalytic converter 110. As discussed above, the array size may be used to organize the cells, and thus the quantities determined by the first module 205, into the three-dimensional model.

At block 520, the first module 205 may determine reaction information specific to the catalytic converter 110. For instance, the first module 205 may determine an inlet condition of the catalytic converter 110. The inlet condition may be determined at a frontal face of a monolith disposed within the catalytic converter 110 by, for example, the second module 210 and communicated to the first module 205. This and other information may further be communicated back and forth between the first module 205 and the second module 210. The first module 205 may further determine a bed temperature and surface coverage of the catalytic converter 110. The inlet condition, the bed temperature, and/or the surface coverage may be provided to the first module 205 by the second module 210 and used by the first module 205 to model chemical reactions at each cell, and thus, at each axial location.

At block 525, the first module 205 may access and execute a computer code used to model chemical reactions. For example, the first module 205 may apply the information from block 520 to the computer code.

At block 530, the first module 205 may solve and output the quantities related to the chemical reactions of the exhaust gases in the catalytic converter 110. The quantities may include the quantity of heat released during the chemical reaction and/or the amount of species consumed or generated during the chemical reaction. The first module 205 may output these quantities to the second module 210 so that the second module 210 may solve the three-dimensional model of the catalytic converter 110. For instance, the second module 210 may receive these quantities at block 415 of the process 400 described above with respect to FIG. 4.

While the best modes for carrying out the invention have been described in detail, those familiar with the art to which this invention relates will recognize various alternative designs and embodiments for practicing the invention within the scope of the appended claims.

1. A computing device comprising:
a first module configured to determine at least one quantity of a chemical reaction at a plurality of axial locations in a catalytic converter, wherein each axial location extends in a direction that is generally parallel to a direction of flow of exhaust gas through the catalytic converter; and
a second module configured to receive the quantity determined by the first module and solve a three-dimensional model of the catalytic converter based at least in part on the received quantity.

2. A computing device as set forth in claim 1, wherein the second module is configured to receive at least one physical dimension of the catalytic converter and solve the three-dimensional model of the catalytic converter based at least in part on the received physical dimension.

3. A computing device as set forth in claim 1, wherein the at least one quantity includes at least one of a quantity of heat released and an amount of species consumed or generated during the chemical reaction.

4. A computing device as set forth in claim 1, wherein the at least one quantity includes a first quantity of heat released during the chemical reaction and a second quantity of heat released during the chemical reaction, and the plurality of axial locations includes a first axial location and a second axial location.

5. A computing device as set forth in claim 4, wherein the first module is configured to determine the first quantity of heat released at the first axial location during the chemical reaction and the second quantity of heat released at the second axial location during the chemical reaction.

6. A computing device as set forth in claim 5, wherein the second module is configured to receive the first quantity of heat released at the first axial location and the second quantity of heat released at the second axial location and solve the three-dimensional model of the catalytic converter based at least in part on the first quantity of heat released and the second quantity of heat released.

7. A computing device as set forth in claim 4, wherein the at least one quantity includes a first amount of species consumed or generated during the chemical reaction and a second amount of species consumed or generated during the chemical reaction, and wherein the plurality of axial locations includes a first axial location and a second axial location.

8. A computing device as set forth in claim 7, wherein the first module is configured to determine the first amount of species consumed or generated at the first axial location and the second amount of species consumed or generated at the second axial location.

9. A computing device as set forth in claim 8, wherein the second module is configured to receive the first amount of species consumed or generated at the first axial location and the second amount of species consumed or generated at the second axial location during the first and second chemical reactions and solve the three-dimensional model of the catalytic converter based at least in part on the first amount of species consumed or generated and the second amount of species consumed or generated.

10. A computing device as set forth in claim 1, wherein the second module is configured to solve the three-dimensional model of the catalytic converter based at least in part on a flow of exhaust through the catalytic converter, a quantity of heat released during the chemical reaction, and an amount of species consumed or generated during the chemical reaction.

11. A method comprising:
determining, via a first module of a computing device, a first quantity of a chemical reaction at a first axial location of a catalytic converter;
determining, via the first module, a second quantity of the chemical reaction at a second axial location of the catalytic converter;
receiving the first and second quantity at a second module of the computing device; and
solving, via the second module, a three-dimensional model of the catalytic converter based at least in part on the first quantity and the second quantity.

12. A method as set forth in claim 11, wherein solving the three-dimensional model includes forming an array with the first and second axial locations.

13. A method as set forth in claim 11, wherein solving the three-dimensional model includes solving, via the second module, the three dimensional model based at least in part on a flow of exhaust through the catalytic converter, the first quantity at the first axial location, and the second quantity at the second axial location.

14. A method as set forth in claim 11, wherein the first quantity and the second quantity each represent a quantity of heat released during the chemical reaction.

15. A method as set forth in claim 11, wherein the first quantity and the second quantity each represent an amount of species consumed or generated during the chemical reaction.

16. A method as set forth in claim 11, wherein the first axial location and the second axial location each extend in a direction that is generally parallel to a direction of flow of exhaust gas through the catalytic converter.

17. A method as set forth in claim 11, wherein the first quantity represents a first quantity of heat released during the chemical reaction and the second quantity represents a second quantity of heat released during the chemical reaction, and further comprising determining, via the first module, a first amount of species consumed or generated during the chemical reaction at the first axial location and a second amount of species consumed or generated during the chemical reaction at the second axial location.

18. A method as set forth in claim 17, wherein generating the three-dimensional model of the catalytic converter includes generating, via the second module, the three-dimensional model of the catalytic converter based at least in part on the first quantity of heat released and the first amount of species consumed or generated at the first axial location during the chemical reaction and the second quantity of heat released and the second amount of species consumed or generated at the second axial location during the chemical reaction.

19. A computing device comprising:
a first module configured to determine a first quantity of heat released and a first amount of species consumed or generated at a first axial location of a catalytic converter during a chemical reaction and a second quantity of heat released and a second amount of species consumed or generated at a second axial location of the catalytic converter during the chemical reaction, wherein the first and second axial locations each extend in a direction that is generally parallel to a direction of flow of exhaust gas through the catalytic converter; and
a second module configured to receive the first quantity of heat released, the second quantity of heat released, the first amount of species consumed or generated, and the second amount of species consumed or generated during the chemical reaction, and wherein the second module is configured to solve the three-dimensional model of the catalytic converter based at least in part on one or more of the first quantity of heat released, the second quantity of heat released, the first amount of species consumed or generated, and the second amount of species consumed or generated during the chemical reaction.
